(19) United States
(12) Patent Application Publication
(10) Pub. No.: US 2005/0237487 A1
(43) Pub. Date: Oct. 27, 2005

(54) Color wheel assembly for stereoscopic imaging

(76) Inventor: Nelson Liang An Chang, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/831,593

(22) Filed: Apr. 23, 2004

(51) Int. Cl. G03B 21/00

(52) U.S. Cl. 353/7

(57) ABSTRACT

A color wheel assembly for use in a projector for stereoscopic imaging. The color wheel assembly includes a first portion able to polarize light in a first orientation and a second portion able to polarize light in a second orientation. The first and second portions allow the color wheel assembly, when in an image projector, to produce separate polarized images to achieve a stereoscopic image.

### TECHNICAL FIELD

The present invention relates to the field of light projection. Specifically, embodiments of the present invention relate to a device and system for projecting an image for three-dimensional viewing.

### BACKGROUND ART

A variety of techniques have been developed to attempt to create realistic three-dimensional images, as perceived by a viewer. One class of such techniques involves using an image projector and a remote display screen. The viewer perceives the image reflected off the display screen as being three-dimensional. However, conventional 3D imaging techniques suffer from one or more limitations. For example, some techniques are very costly, while others produce poor quality images.

Conventional techniques to deliver an image that a viewer can perceive as three-dimensional can be classified into passive approaches and active approaches. Some passive approaches achieve the perception of three-dimensions by using an image projector to project two related images onto a display screen. Typically, the related images are first and second viewpoints of the same scene. If a viewer processes one image with each eye, then the viewer receives one viewpoint of the scene in each eye. The viewer's visual processing interprets these two related viewpoints as a three-dimensional image of the scene. The technique can also send streams of images to achieve a 3D movie effect.

Conventional passive 3D techniques commonly employ one or two image projectors. The viewer wears special glasses such that the viewer will perceive the correct images appropriate for each eye. In one conventional passive technique, the glasses that the viewer wears have a red filter for the left eye and a blue filter for the right eye. In this case, a single projector displays the appropriately filtered images such that the viewer receives one image with each eye. However, the filtering that this conventional technique requires considerably alters the color spectrum of the scene, often leading to a very unnatural and unrealistic representation of the underlying scene.

The use of polarization is another conventional passive technique for achieving a three-dimensional effect. This conventional technique delivers two related images that are polarized in a different fashion from one another. In this technique, the viewer wears glasses having lenses that are polarized in a different manner from each other. For example, one lens may be polarized in a horizontal orientation and the other in a vertical orientation. Two projectors are used, each delivering an image that is polarized such that the viewer wearing the polarized lenses will perceive the image from one projector with one eye and the other projector with the other eye with minimal crosstalk. This conventional system is costly, as it typically requires two projectors. Moreover, if two projectors are used, they must be aligned very accurately such that the two images are correctly aligned on the display screen.

Another conventional passive technique for projecting a three-dimensional image is an auto-stereoscopic technique. Conventional auto-stereoscopic techniques do not require special glasses and do not use multiple projectors. These techniques send multiple viewpoints of a scene to a special display screen that is able to direct each of the viewpoints to a slightly different location in the viewer space. The intent is for the viewer to see a pair of viewpoints at a time. Based on the viewer's position, the light rays corresponding to one viewpoint will automatically be sent to the left eye and those corresponding to a second viewpoint will go to the right eye, thereby effecting stereo perception. Unfortunately, auto-stereoscopic techniques have poor spatial resolution because the display screen is divided to handle the multiple viewpoints. For example, if the scene comprises nine viewpoints, then every ninth column of the display is assigned to one of the viewpoints.

Other conventional techniques for projecting a three-dimensional image may be described as active techniques. One conventional active technique uses special active glasses that allow an image into one eye of the viewer while blocking that same image from entering the other eye. For example, the glasses may have liquid crystal shutters that open and close, such that whatever image is on the display screen is alternately received by the right eye and the left eye. This system alternates the image on the display screen such that the viewers right and left eyes receive a different viewpoint of the scene being displayed. However, the glasses must be accurately synchronized with the projector that sends the images to the display. Thus, these systems can be very expensive and complex to achieve the necessary synchronization between the glasses and the signal source.

Another active conventional technique for three-dimensional image projection uses a special active polarized shutter in front of a projector. The polarized shutter alternates the polarization of the light between a first and a second polarization, typically tens of times per second. The projector synchronizes the sending of a first and a second viewpoint of a scene with the first and second polarizations. The viewer wears passive polarized glasses that allow one type of polarization into each eye, such that each eye receives one of the viewpoints and minimizes crosstalk. In this manner, the viewer receives a stereoscopic image pair. As with other active techniques, the active polarizing shutter can be expensive. Moreover, while this conventional technique requires only a single projector, it may require a second light-processing chip within projector to create the second image.

Thus, one problem with conventional techniques for projecting an image for three-dimensional viewing is the cost of the system. Poor image quality is a problem with some conventional 3D techniques. Other conventional 3D techniques require complex and difficult coordination between the components of the system to produce a quality image.

### DISCLOSURE OF THE INVENTION

Embodiments of the present invention pertain to a color wheel assembly for use in a projector for stereoscopic imaging. In accordance with an embodiment of the present invention, the color wheel assembly comprises a first portion operable to polarize light in a first orientation and a second portion operable to polarize light in a second orientation. The first and second portions allow the color wheel assembly, when in an image projector, to produce separate polarized images to achieve a stereoscopic image.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1A illustrates an exemplary color wheel for stereoscopic imaging, in accordance with an embodiment of the present invention.

FIG. 1B illustrates a side view of the exemplary color wheel of FIG. 1A.

FIG. 1C illustrates a color wheel in accordance with an embodiment of the present invention in which each polarizing portion is non-contiguous.

FIG. 2A is a diagram of a projector for achieving stereoscopic images using a common polarizing color wheel, in accordance with an embodiment of the present invention.

FIG. 2B depicts a projector for achieving stereoscopic images in which a color wheel is located in the overall light path after unpolarized light reflects off from an image reflection region, in accordance with an embodiment of the present invention.

FIG. 3 illustrates a system for achieving stereoscopic images using a polarizing color wheel, in accordance with an embodiment of the present invention.

FIG. 4 is a diagram of a projector for achieving stereoscopic images using two polarizing color wheels, in accordance with an embodiment of the present invention.

FIG. 5 is a flowchart illustrating a process of projecting a stereoscopic image, in accordance with an embodiment of the present invention.

### DETAILED DESCRIPTION OF THE INVENTION

In the following detailed description of embodiments of the present invention, a color wheel assembly for stereoscopic imaging, numerous specific details are set forth in order to provide a thorough understanding of the present invention. However, embodiments of the present invention may be practiced without these specific details or by using alternative elements or methods. In other instances, well known methods, procedures, components, and circuits have not been described in detail as not to unnecessarily obscure aspects of the present invention.

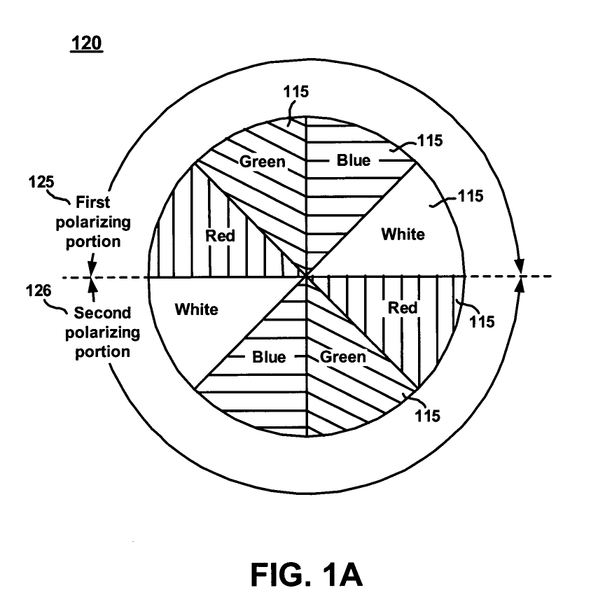

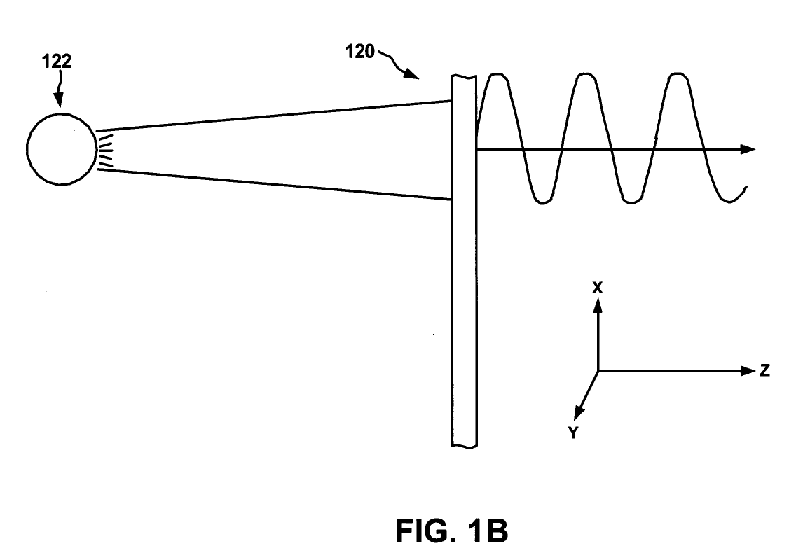

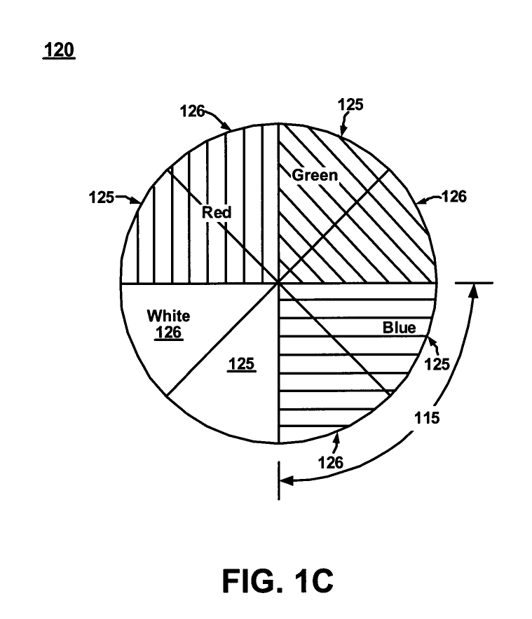

FIG. 1A illustrates an exemplary polarizing color wheel 120 for stereoscopic imaging, in accordance with an embodiment of the present invention. The exemplary polarizing color wheel 120 comprises red, green, blue, and white (or colorless) regions 115. However, the color scheme is not critical to the invention. For example, a purple/yellow color scheme could be used instead of a red/green/blue scheme. In another embodiment, a cyan/magenta/yellow color scheme is used. For purposes of the present application, the term “color” is intended to include any color including black, white, and shades of gray. It will be understood that the polarizing color wheel 120 may be used for the stereoscopic projection of gray-scale images. Furthermore, it is not required that all the regions 115 be of equal size. It will be further understood that the color wheel 120 is not required to be round.

The exemplary color wheel 120 in FIG. 1A comprises a first polarizing portion 125 that is operable to polarize light in a first orientation and a second polarizing portion 126 that is operable to polarize light in a second orientation. Throughout this description the portions may also be referred to as light transmission apparatus. The present invention is not limited to any particular first and second orientations. When used in an image projector, the polarizing color wheel 120 is able to produce separate polarized images to achieve a stereoscopic image, as discussed more fully below. Moreover, embodiments of the present invention use only a single image projector to achieve a stereoscopic image.

The first polarizing portion 125 comprises one each of the red, blue, green, and white regions 115, in the embodiment depicted in FIG. 1A. The second polarizing portion 126 comprises the remaining red, blue, green, and white regions 115, in this embodiment. The polarizing color wheel 120 can be rotated while in an image projector in order to filter a light source with one of the regions 115 at a time. Such rotation will produce light that is filtered with an appropriate color scheme and also is polarized with one of the two orientations of polarization. Thus, this embodiment is able to achieve stereoscopic projection with a single image projector.

FIG. 1B illustrates a side view of the exemplary polarizing color wheel 120 of FIG. 1A. The light from the light source 122 is polarized by the polarizing color wheel 120 with one of two orientations. FIG. 1B depicts a representation of a light wave traveling in the z direction that has been polarized by the polarizing color wheel 120 parallel to the depicted x-axis. The light is polarized parallel to either the x-axis or the y-axis when passing through the color wheel 120, depending on which polarization portion (FIG. 1, 125, 126) the light is passing through. For example, in FIG. 1B, the light may be passing through one of the green regions of the color wheel 120. It is not necessary for the light to be polarized parallel to any of the depicted axes.

In one embodiment, the two orientations of polarization are complimentary to one another. For example, the orientations are separated from one another by 90 degrees. However, the two orientations do not have to be complimentary.

FIG. 1B depicts an embodiment that polarizes the light linearly. However, the present invention is not limited to using linear polarization. Another embodiment in accordance with the present invention polarizes the light in a circular (or elliptical) manner.

Furthermore, it is not required that the two polarizing portions be continuous regions. FIG. 1C illustrates an embodiment in which each color region 115 comprises a first portion 125 that polarizes in a first orientation and a second portion 126 that polarizes in a second orientation. Thus, the first polarizing portion 125 comprises separate regions on the polarizing color wheel 120, as does the second polarizing portion 126.

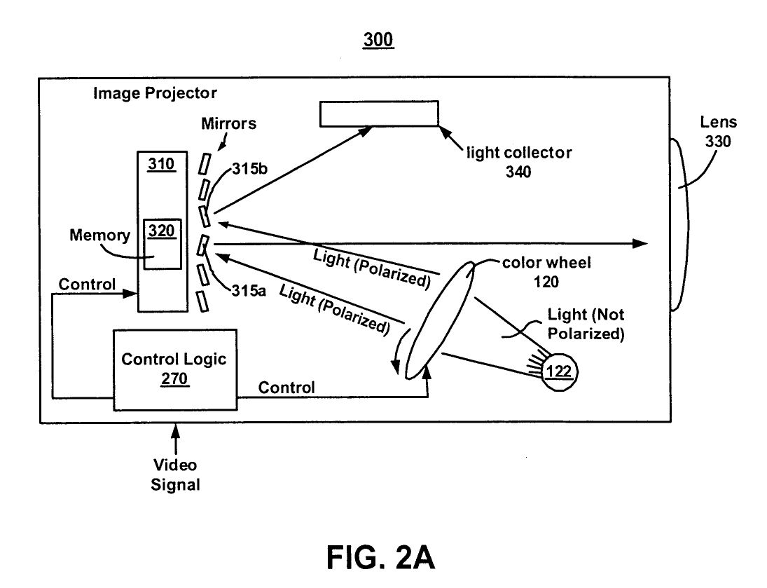

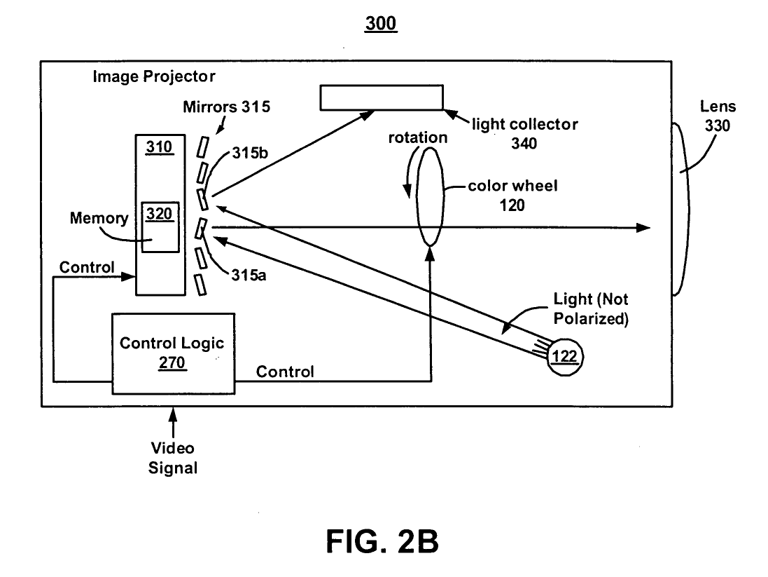

FIG. 2A is a diagram of a projector 300 for achieving stereoscopic images using one color wheel 120, in accordance with an embodiment of the present invention. This embodiment includes an image reflection region 310. In one embodiment, the image reflection region is comprised of a Digital Micromirror Device (DMD™). However, the present invention can be used with projectors not employing a DMD™ or the like. The image reflection region 310 comprises thousands of very small mirrors 315. Only a very few of the mirrors 315 are depicted in FIG. 2A. As an example, the mirrors 315 may be on the order of 16×16 micrometers. Each mirror 315 is capable of switching a pixel of light. The mirrors 315 are fabricated on hinges atop a memory unit 320. The hinges allow the mirrors 315 to tilt between an “on state” and an “off state”. For example, the polarized light from the color wheel 120 reflects off from mirror 315a and exits the projector 300 via the outer lens 330. Therefore, mirror 315a is in an “on state.” However, the polarized light from the color wheel 120 reflects off from mirror 315b to strike the light collector 340. Therefore, mirror 315b is in an “off state.” All of the mirrors 315 are used for a single color at a time. The polarizing color wheel 120 rotates such that the set of mirrors 315 progressively reflects red, then blue, then green, then white, in one embodiment. However, the color scheme is not critical to the invention.

The control logic 270 controls the orientation of the mirrors 315 by electrically addressing the memory unit 320. For example, a mirror 315 can be controlled between the “on” or “off” state by a single bit in memory 320. The mirrors 315 can be switched on and off more than 1000 times per second. The video signal may comprise two channels, each channel containing one perspective or viewpoint of a scene. The two channels are polarized by the image projector 300 with distinct orientations, such that a stereoscopic image is produced. Each channel of the video signal is split into, for example, its constituent red, green, and blue image components (RGB data). “White” image data coming from the luminance component of the video signal may be created for each channel, as well. In a non-stereoscopic projector with a conventional color wheel, there are typically four such data sets for each video frame. In contrast, there are eight data sets for each video frame in this embodiment. Each pixel of a given frame is mapped directly to one of the mirrors 315. Note that the video signal may multiplex the two channels temporally, spatially, or a combination of the two.

The control logic 270 is synchronized to the color wheel 120, such that the information the control logic 270 sends to the bank of mirrors 315 corresponds to the correct position of the polarizing color wheel 120. In the embodiment of FIG. 2A, the control logic 270 controls the color wheel 120. The control logic 270 may also receive information indicating which portion of the color wheel 120 is in the light path. As the color wheel rotates through the colors and polarization orientations, the control logic 270 sends the corresponding data to the mirrors 315 to ensure that the correct component image for each time instance is output. For example, the control logic 270 sends one frame of control data corresponding to the red component for a first channel (e.g., viewpoint) when the color wheel 120 is allowing red light that is polarized with a first orientation to fall on the bank of mirrors 315. When the color wheel 120 has rotated to the point at which the color wheel 120 is allowing green light that is polarized with the first orientation to fall on the bank of mirrors 315, the control logic 270 sends one frame of control data corresponding to the green component for the first channel to adjust the mirrors accordingly.

In the embodiment depicted in FIG. 2A, those of ordinary skill in the art will recognize that the image reflection region 315 is constructed such that it will preserve the light polarization of the light from the color wheel 120. FIG. 2B depicts an embodiment of the present invention in which the color wheel 120 is located in the overall light path after the unpolarized light reflects off from the image reflection region 310. Thus, in accordance with this embodiment, the mirrors 315 need not preserve light polarization.

Those of ordinary skill in the art will appreciate that many modifications are possible to the image projectors of FIGS. 2A and 2B. For example, additional hardware such as mirrors and lenses may be placed in the optical path for reasons such as improving and focusing the final projected image. Moreover, it will be understood that embodiments of the present invention are not limited to any particular configuration of light source, image reflection region, and color wheel.

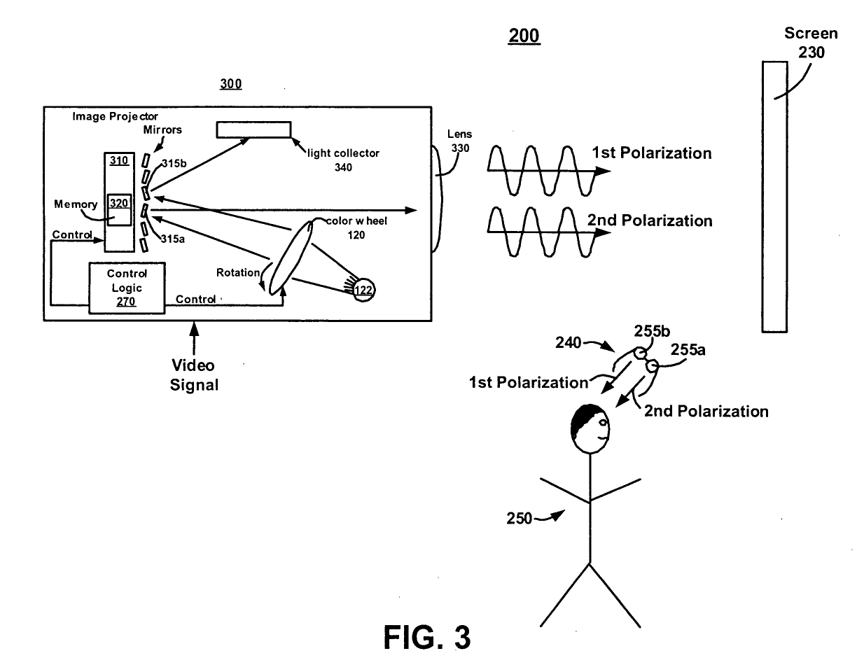

FIG. 3 illustrates a system 200 for achieving stereoscopic images using polarization, in accordance with an embodiment of the present invention. The system 200 illustrated in FIG. 3 comprises a stereoscopic image projector 300, a projection screen 230, and at least one pair of polarized viewing glasses 240. The glasses are worn by a viewer 250. The projection screen 230 is typically a polarization-preserving screen to ensure that the two polarization orientations are retained during projection.

The image projector 300 includes a polarizing color wheel 120 that is capable of polarizing light in two distinct orientations. The image projector 300 also has logic 270 that is operable to cause the image projector 300 to alternate between emitting a first viewpoint of a scene polarized by a first light transmission apparatus (e.g. the first portion 125, as shown in FIGS. 1A and 1C) and a second viewpoint of the scene polarized by a second light transmission apparatus (e.g. the second portion 126, as shown in FIGS. 1A and 1C), wherein the image projector 300 projects a stereoscopic image. For example, a video signal that comprises at least two viewpoints of a scene is fed into the image projector 300. The video signal may be formed in any convenient fashion and may be in analog or digital format. The video signal may be pre-stored, although this is not required. The control logic 270 receives the video signal, splits the video signal and controls the image projector 300 such that one viewpoint is polarized with a first polarization and the other viewpoint is polarized with a second polarization. As a result, one embodiment of the present invention allows a single color wheel having multiple polarizations to achieve stereoscopic imaging with only a single projector. In accordance with embodiments of the invention, the projector alternates between the two viewpoints at a rate faster than the viewer can perceive, so that the viewer does not notice any flickering. In another embodiment, two color wheels are used in a single projector to achieve stereoscopic image projection. Furthermore, embodiments of the present invention do not require a complex active shutter plate associated with the image projector.

The viewer 250 wears passive polarized glasses 240 with a first light transmission medium 255a that selectively transmits one of the orientations of polarized light. For example, the first light transmission medium 255a substantially transmits one orientation of polarization to the right eye and substantially blocks another orientation to the right eye. The second light transmission medium 255b is constructed to selectively transmit to the left eye the light polarized with the orientation that is substantially blocked to the right eye. Thus, the left eye receives the light polarized in one orientation and the right eye the other orientation. It is not critical which orientation is received by each eye, as long as each eye receives the intended image. Although not ideal, it is acceptable for some crosstalk to occur. For example, each eye can receive some of the light intended for the other eye. The net result is that the left eye receives substantially one viewpoint and the right eye receives substantially the other viewpoint. Upon processing the two viewpoints, the viewer 250 perceives a three-dimensional image of the scene. Thus, embodiments of the present invention do not require complex synchronization between an image projector and viewing glasses. Moreover, embodiments of the present invention do not require complex active shutter glasses.

In the embodiment in which the polarized color wheel 120 polarizes the images along the x-axis and y-axis, the passive polarized glasses 240 are polarized such that one eye receives the image that is polarized along the x-axis and the other eye receives the light that is polarized along the y-axis (axes depicted in FIG. 1B).

Unlike some conventional systems for delivering a three-dimensional image, the viewer 250 can be positioned at a wide range of angles with respect to the viewing screen 230 and still perceive an effective three-dimensional image. This is because the polarization of the light reflected off from the viewing screen is not significantly dependent upon the viewing angle.

Moreover, the present invention does not require synchronization between a projector and the viewer's glasses. Therefore, the present invention is much simpler than conventional stereoscopic systems that require complex and expensive synchronization between the image source and the viewer's glasses.

As previously discussed, the color wheel 120 may use many different color schemes and placements of the polarizing portions. The control logic 270 can be programmed to identify the characteristics of the color wheel 120, such that the control logic 270 can be used with color wheels 120 with different configurations. In one embodiment, the color wheel 120 has markings, such as a bar code or the like, which can be read by a component in the image projector 300 to indicate the color wheel's characteristics.

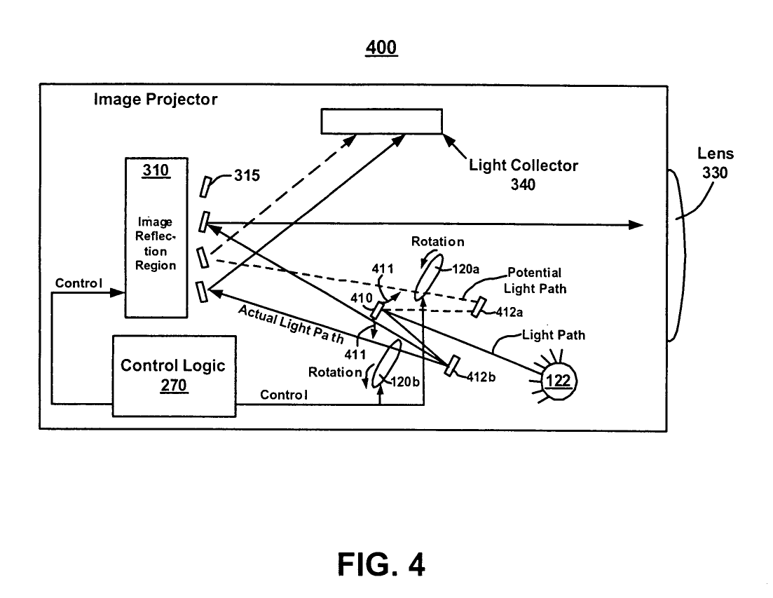

FIG. 4 is a projector 400 for achieving stereoscopic images using a color wheel assembly that comprises two polarizing color wheels 120, in accordance with an embodiment of the present invention. In this embodiment, a splitting mirror 410 is rotated back and forth, as indicated by arrows 411, to direct the light from the light source 122 to one of the back mirrors 412a, 412b, which redirect the light to a respective polarizing color wheel 120a, 120b. An actual light path is depicted as a solid line from the light source 122 off mirror 410 and then mirror 412b to indicate the path of light at one point in time. A potential light path is depicted from mirror 410 to mirror 412a and reflecting off mirror 412a to indicate a potential light path if the mirror 410 were positioned to reflect light towards 412a. All of the regions of a given polarizing color wheel 120a, 120b polarize light in the same orientation, in this embodiment. However, color wheel 120a polarizes light in a different orientation from color wheel 120b. The embodiment of FIG. 4 uses a Digital Micromirror Device 310. However, a DMD™ device or the like is not required by the present invention.

In yet another embodiment in accordance with the present invention in which two separate color wheels are used, the color wheels are physically moved into and out of the light path, such that one or the other color wheel filters the light.

The color wheels of various embodiments described herein may also be used to project a non-stereoscopic image. For example, the control logic 270 of either image projector 300, 400 can be programmed to send image data that is for a monoscopic image. In this embodiment, the control logic 270 ignores the polarization aspect of the color wheel 120. The light that is projected will be polarized, but because the human eye is relatively insensitive to differences in polarization, the viewer will perceive a monoscopic image.

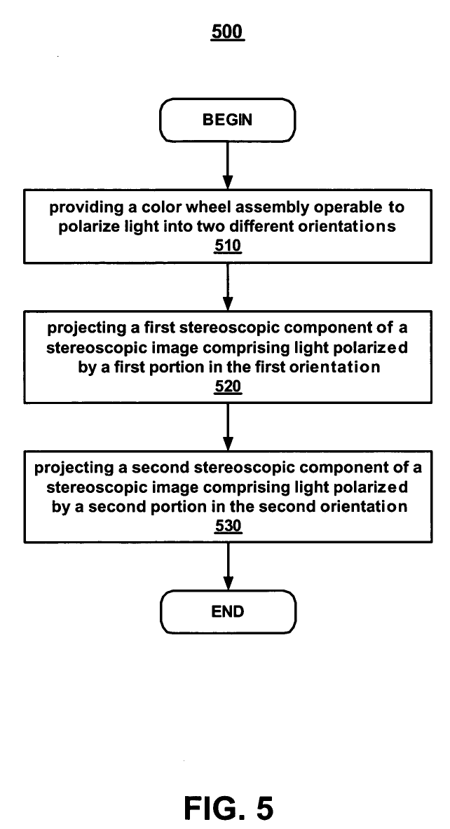

FIG. 5 is a flowchart illustrating a process 500 of projecting a stereoscopic image, in accordance with an embodiment of the present invention. In step 510, a color wheel assembly is provided. The color wheel assembly comprises a first portion operable to polarize light in a first orientation and a second portion operable to polarize light in a second orientation. The first and second portions may be on a common color wheel or, alternatively may reside on separate color wheels.

In step 520, a first stereoscopic component of a stereoscopic image comprising light polarized by the first portion in the first orientation is projected. Step 520 may comprise controlling an image reflection region such that light that is polarized by the first portion forms the first stereoscopic component of the stereoscopic image.

In step 530, a second stereoscopic component of a stereoscopic image comprising light polarized by the second portion in the second orientation is projected.

While the present invention has been described in particular embodiments, it should be appreciated that the present invention should not be construed as limited by such embodiments, but rather construed according to the below claims.

1. A color wheel assembly for use in a projector for stereoscopic imaging, said color wheel assembly comprising:
a first portion operable to polarize light in a first orientation; and
a second portion operable to polarize light in a second orientation, such that said color wheel assembly is operable in an image projector to produce separate polarized images achieving a stereoscopic image.

2. The color wheel assembly of claim 1, wherein said first portion and said second portion reside on a common color wheel.

3. The color wheel assembly of claim 1, wherein said first portion and said second portion reside on separate color wheels.

4. The color wheel assembly of claim 1, wherein said first portion and second portions are operable to linearly polarize light.

5. The color wheel assembly of claim 1, wherein said first and second portions are operable to circularly polarize light.

6. The color wheel assembly of claim 1, wherein said first portion and second portions comprise regions corresponding to different colors.

7. The color wheel assembly of claim 6, wherein the different colors comprise red, green, and blue.

8. The color wheel assembly of claim 6, wherein the different colors comprise cyan, yellow, and magenta.

9. A image projector for stereoscopic imaging comprising:
a first light transmission apparatus configured in the projector to polarize light in a first orientation; and
a second transmission apparatus configured in the projector to polarize light in a second orientation relative to the first orientation; and
logic operable to cause the image projector to alternate between emitting a first viewpoint of a scene comprising light polarized by the first light transmission apparatus and a second viewpoint of the scene comprising light polarized by the second light transmission apparatus, wherein the image projector projects a stereoscopic image.

10. The image projector of claim 9, wherein said first light transmission apparatus and said second light transmission apparatus reside on a common color wheel.

11. The image projector of claim 9, wherein said first light transmission apparatus resides on a first color wheel and said second light transmission apparatus resides on a second color wheel.

12. The image projector of claim 9, further comprising:
an image reflection region electrically coupled to said logic and optically coupled to said first and second light transmission apparatus, wherein said logic is operable to control said image reflection region, based on which of said first light transmission apparatus and said second light transmission apparatus are causing polarized light to fall on the image reflection region.

13. The image projector of claim 9, further comprising:
a light source; and
a set of mirrors configured to alternate an optical coupling of said light source between said first light transmission apparatus and said second transmission apparatus, wherein said first light transmission apparatus and said second transmission apparatus reside on separate color wheels.

14. The image projector of claim 9, wherein said logic is further operable to cause the image projector to project sequential images of a scene comprising a single viewpoint by alternatingly polarizing the sequential images between the first light transmission apparatus and the second light transmission apparatus, wherein the image projector projects a non-stereoscopic image.

15. The image projector of claim 9, wherein said first and second light transmission apparatus are operable to linearly polarize light.

16. The image projector of claim 9, wherein said first and second light transmission apparatus are operable to circularly polarize light.

17. A system for achieving stereoscopic images, comprising:
an image projector comprising:
a color wheel assembly having a first portion configured in the projector to polarize light in a first orientation and a second portion configured in the projector to polarize light in a second orientation relative to the first orientation;
logic operable to cause the image projector to emit a signal comprising a first stereoscopic component and a second stereoscopic component by polarizing light respectively with the first portion and the second portion, such that the image projector projects a stereoscopic image; and
viewer glasses having a first light transmission medium and a second light transmission medium, said first and second light transmission media operable to selectively transmit, respectively, said first and second stereoscopic components.

18. The system of claim 17, wherein said first portion and said second portion reside on the same color wheel.

19. The system of claim 17, wherein said first portion resides on a first color wheel and said second portion resides on a second color wheel.

20. The system of claim 17, wherein said first portion and said second portion are operable to linearly polarize light.

21. The system of claim 17, wherein said first portion and said second portion are operable to circularly polarize light.

22. The system of claim 17, further comprising:
an image reflection region electrically coupled to said logic and optically coupled to said first and second portions, wherein said logic is operable to control said image reflection region to cause the first viewpoint of the scene to comprise light polarized by said first portion and the second viewpoint of the scene to comprise light polarized by said second portion.

23. The system of claim 17, further comprising:
a light source; and
a set of mirrors configured to optically couple said light source alternatingly between said first portion and said second portion.

24. The system of claim 17, wherein said logic is further operable to cause the image projector to emit sequential images of a scene comprising a single viewpoint by alternatingly polarizing the sequential images between the first portion and the second portion, wherein the image projector projects a non-stereoscopic image.

25. The system of claim 17, wherein said first light transmission medium and said second light transmission medium of the viewer glasses are passive components.

26. The system of claim 17, further comprising a polarization-preserving display screen optically coupled to the image projector.

27. A method of projecting a stereoscopic image, comprising:
providing a color wheel assembly comprising:
a first portion operable to polarize light in a first orientation; and
a second portion operable to polarize light in a second orientation;
projecting a first stereoscopic component of a stereoscopic image comprising light polarized by the first portion in the first orientation; and
projecting a second stereoscopic component of the stereoscopic image comprising light polarized by the second portion in the second orientation, wherein said first and second stereoscopic components achieve the stereoscopic image.

28. The method of claim 27, wherein said providing a color wheel assembly comprises providing said first and second portions on a common color wheel.

29. The method of claim 27, wherein said providing a color wheel assembly comprises providing said first and second portions on a separate color wheels.

30. The method of claim 27, wherein said projecting the first stereoscopic component comprises controlling an image reflection region such that light that is polarized by the first portion forms the first stereoscopic component of the stereoscopic image.
